(19) United States
(12) Patent Application Publication
(10) Pub. No.: US 2022/0390925 A1
(43) Pub. Date: Dec. 8, 2022

(54) SENSOR SYSTEM, MASTER UNIT, PREDICTION DEVICE, AND PREDICTION METHOD

(71) Applicant: OMRON Corporation, KYOTO (JP)

(72) Inventors: Yusuke IIDA, Kyoto-shi, KYOTO (JP); Norihiro TOMAGO, Kyoto-shi, KYOTO (JP); Kohei TANISUE, Kyoto-shi, KYOTO (JP); Yutaka KATO, Kyoto-shi, KYOTO (JP); Masanori TAKAHASHI, Kyoto-shi, KYOTO (JP)

(73) Assignee: OMRON Corporation, KYOTO (JP)

(21) Appl. No.: 17/776,236

(22) PCT Filed: Dec. 1, 2020
(86) PCT No.: PCT/JP2020/044584

§ 371 Date: May 12, 2022

(30) Foreign Application Priority Data
Dec. 5, 2019 (JP) 2019-220520

(51) Int. Cl. G05B 19/418; G05B 23/02

(52) U.S. Cl. CPC G05B 19/4183; G05B 23/02; G06N 20/00

(57) ABSTRACT

The present invention can detect early an abnormality or signs of abnormality in a workpiece. A sensor system 1 is provided with: a first sensor 30a that measures a workpiece; a second sensor 30b that measures the workpiece in a relatively longer cycle than the first sensor 30a; and a master unit 10. The master unit 10 includes: an acquisition unit 11 that acquires data measured by the first sensor 30a and data measured by the second sensor 30b; and a generation unit 12 that generates learning data which is used for machine learning of a learning model and in which the acquired data of the first sensor 30a is regarded as input data and the acquired data of the second sensor 30b is regarded as label data indicating a property of the input data.

### TECHNICAL FIELD

The present disclosure relates to a sensor system, a master unit, a prediction device, and a prediction method.

### BACKGROUND ART

In the related art, a plurality of sensors is installed along a line and it is detected whether there is a workpiece transported along the line. Data measured by the plurality of sensors is acquired by a plurality of slave units, transmitted to a master unit, and collected by a control device such as a programmable logic controller (PLC) connected to the master unit.

The following Patent Literature 1 discloses a sensor system including a plurality of sensor units and a communication device that transmits information received from each sensor unit to a control device. After a waiting time determined for each sensor unit has passed, each sensor unit transmits detected information such as sensed data to the communication device by using a synchronization signal transmitted from any sensor unit as a source. Here, the waiting time of each sensor unit is set to differ from the waiting times of the other sensor units.

According to the technology disclosed in Patent Literature 1, data can be transmitted without awaiting a command from the control device when data measured by the plurality of sensors is collected in the control device. Thus, it is possible to improve a communication speed.

### CITATION LIST

### Patent Literature

### Patent Literature 1

Japanese Patent Laid-Open No. 2014-96036

### SUMMARY OF INVENTION

### Technical Problem

In recent years, studies for constructing sensor systems that generate learned models using data measured by a plurality of sensors in machine learning of a learning model and perform more advanced determination in accordance with the learned models have been conducted.

In the related art, as sensor systems using learned models, sensor systems that detect abnormalities or signs or symptoms of abnormalities in workpieces transported on lines by using learned models generated from data measured by a plurality of sensors installed in the lines have been proposed.

However, in such sensor systems, there have been requests for detecting abnormalities or signs or symptoms of abnormalities in workpieces as quickly as possible and inhibiting the abnormal workpieces from being manufactured or generated.

Accordingly, an objective of the present invention is to provide a sensor system, a master unit, a prediction device, and a prediction method capable of detecting an abnormality or a sign of an abnormality in a workpiece early.

### Solution to Problem

According to an aspect of the present disclosure, a sensor system includes: a first sensor configured to measure a workpiece; a second sensor configured to measure the workpiece in a relatively longer cycle than the first sensor; and a master unit. The master unit includes an acquisition unit that acquires data measured by the first sensor and data measured by the second sensor, and a generation unit that generates learning data which is used for machine learning of a learning model and in which the acquired data of the first sensor is regarded as input data and the acquired data of the second sensor is regarded as label data indicating a property of the input data.

According to this aspect, the learning data which is used for the machine learning of the learning model and in which the acquired data of the first sensor is regarded as the input data and the acquired data of the second sensor is regarded as the label data indicating the property of the input data is generated. Thus, the learned model generated using the learning data can output a value (a predicted value) using the data of the first sensor, of which a measurement cycle is relatively shorter than that of the second sensor, as an input. Accordingly, by using the learned model, it is possible to detect an abnormality or a sign of an abnormality of a workpiece earlier than in the related art.

According to the above-described aspect, the generation unit may generate the learning data by matching the input data to the label data based on a time difference calculated from a movement speed of the workpiece and a distance between the first sensor and the second sensor, a measurement cycle of the first sensor, and a measurement cycle of the second sensor.

According to this aspect, the learning data is generated by matching the input data to the label data based on the time difference, the measurement cycle of the first sensor, and the measurement cycle of the second sensor. Thus, since the learning data is generated by matching the data measured with regard to the same or similar workpieces, it is possible to improve prediction accuracy of the learned model.

According to the above-described aspect, the first sensor may be installed upstream from the second sensor in a line in which the workpiece is moving.

According to this aspect, the first sensor is installed upstream from the second sensor in the line in which the workpiece is moving. Thus, compared to a case in which the first sensor is installed downstream from the second sensor, the data measured with regard to the workpiece in a relatively earlier stage of the line is regarded as input data in the generated learned model. Therefore, it is possible to predict an abnormality or a sign of an abnormality of the workpiece early.

According to the above-described aspect, the master unit may further include a learning unit that performs machine learning of the learning model using the learning data to generate a learned model.

According to this aspect, the machine learning of the learning model is performed using the learning data to generate the learned model. Thus, it is possible to easily generate the learned model that detects an abnormality or a sign of an abnormality of the workpiece early.

According to the above-described aspect, the master unit may further include a prediction unit that inputs the acquired data of the first sensor to the learned model and causes the learned model to output a predicted value.

According to this aspect, the acquired data of the first sensor is input to the learned model and the learned model is caused to output the predicted value. Thus, it is possible to predict an abnormality or a sign of an abnormality of the workpiece early in accordance with the predicted value.

According to the above-described aspect, a plurality of the first sensors may be included. The master unit may further include a selection unit that calculates, for one of the plurality of first sensors, a correlation coefficient between the acquired data of the first sensor and the acquired data of the second sensor.

According to this aspect, for one of the plurality of first sensors, the correlation coefficient between the acquired data of the first sensor and the acquired data of the second sensor is calculated. Thus, it is possible to select the first sensor measuring the data with a linear relation with the data of the second sensor or close to the linear relation among the plurality of first sensors.

According to the above-described aspect, a plurality of the first sensors may be included. The generation unit may generate learning data in which data acquired from at least one of the plurality of first sensors is regarded as input data. The master unit may further include a selection unit that calculates a learning progress value indicating a ratio of learning progress of the learned model based on the acquired data of the second sensor and a predicted value output by inputting the input data to the learned model generated by performing the machine learning of the learning model using the learning data.

According to this aspect, the learning progress value is calculated based on the acquired data of the second sensor and the predicted value output by inputting the input data to the learned model generated by performing the machine learning of the learning model using the learning data. Thus, by selecting at least one of the plurality of first sensors 30a based on the learning progress value, it is possible to select the first sensor in which a predicted value of the learned model generated from the data of the first sensor is close to a value of the data of the second sensor.

According to another aspect of the present disclosure, a master unit is used for a sensor system including a first sensor configured to measure a workpiece and a second sensor configured to measure the workpiece in a relatively longer cycle than the first sensor. The master unit includes: an acquisition unit configured to acquire data measured by the first sensor and data measured by the second sensor; and a generation unit that generates learning data which is used for machine learning of a learning model and in which the acquired data of the first sensor is regarded as input data and the acquired data of the second sensor is regarded as label data indicating a property of the input data.

According to this aspect, the learning data which is used for machine learning of a learning model and in which the acquired data of the first sensor is regarded as input data and the acquired data of the second sensor is regarded as label data indicating a property of the input data is generated. Thus, the learned model generated using the learning data can output a value (a predicted value) using the data of the first sensor, of which a measurement cycle is relatively shorter than that of the second sensor, as an input. Accordingly, by using the learned model, it is possible to detect an abnormality or a sign of an abnormality of a workpiece earlier than in the related art.

According to the above-described aspect, the generation unit may generate the learning data by matching the input data to the label data based on a time difference calculated from a movement speed of the workpiece and a distance between the first sensor and the second sensor, a measurement cycle of the first sensor, and a measurement cycle of the second sensor.

According to this aspect, the learning data is generated by matching the input data to the label data based on the time difference, the measurement cycle of the first sensor, and the measurement cycle of the second sensor. Thus, since the learning data is generated by matching the data measured with regard to the same or similar workpieces, it is possible to improve prediction accuracy of the learned model.

According to the above-described aspect, the master unit may further include a learning unit configured to perform machine learning of the learning model using the learning data to generate a learned model.

According to this aspect, the machine learning of the learning model using the learning data is performed to generate the learned model. Thus, it is possible to easily generate the learned model that detects an abnormality or a sign of an abnormality of the workpiece early.

According to the above-described aspect, the master unit may further include a prediction unit configured to input the acquired data of the first sensor to the learned model and cause the learned model to output a predicted value.

According to this aspect, the acquired data of the first sensor is input to the learned model and the learned model is caused to output a predicted value. Thus, it is possible to predict an abnormality or a sign of an abnormality of the workpiece early in accordance with the predicted value.

According to the above-described aspect, the sensor system may include a plurality of the first sensors. The master unit may further include a selection unit that calculates, for one of the plurality of first sensors, a correlation coefficient between the acquired data of the first sensor and the acquired data of the second sensor

According to this aspect, for one of the plurality of first sensors, the correlation coefficient between the acquired data of the first sensor and the acquired data of the second sensor is calculated. Thus, it is possible to select the first sensor measuring the data with a linear relation with the data of the second sensor or close to the linear relation among the plurality of first sensors.

According to the above-described aspect, the sensor system may include a plurality of the first sensors. The generation unit may generate learning data in which data acquired from at least one of the plurality of first sensors is regarded as input data. The master unit may further include a selection unit that calculates a learning progress value indicating a ratio of learning progress of the learned model based on the acquired data of the second sensor and a predicted value output by inputting the input data to the learned model generated by performing the machine learning of the learning model using the learning data.

According to this aspect, the learning progress value is calculated based on the acquired data of the second sensor and the predicted value output by inputting the input data to the learned model generated by performing the machine learning of the learning model using the learning data. Thus, by selecting at least one of the plurality of first sensors 30a based on the learning progress value, it is possible to select the first sensor in which a predicted value of the learned model generated from the data of the first sensor is close to a value of the data of the second sensor.

According to still another aspect of the present disclosure, a prediction device predicts an abnormality or a sign of an abnormality of a workpiece. The prediction device includes: an acquisition unit configured to acquire data measured by a first sensor measuring the workpiece;

and a prediction unit configured to input the acquired data of the first sensor to a learned model and cause the learned model to output a predicted value. The learned model is generated by performing machine learning of a learning model using learning data generated when the data of the first sensor is regarded as input data and data of a second sensor measuring the workpiece in a relatively longer cycle than the first sensor is regarded as label data indicating a property of the input data.

According to this aspect, the acquired data of the first sensor is input to the learned model and the learned model is caused to output a predicted value. Here, since the learned model is generated using the learning data generated when the data of the first sensor is regarded as the input data and the data of the second sensor is regarded as the label data indicating the property of the input data, the predicted value can be output using the data of the first sensor of which the measurement cycle is relatively shorter than that of the second sensor as an input. Thus, it is possible to predict an abnormality or a sign of an abnormality of the workpiece early in accordance with the predicted value.

According to still another aspect of the present disclosure, there is provided a prediction method of predicting an abnormality or a sign of an abnormality of a workpiece. The method includes: acquiring data measured by a first sensor measuring the workpiece; and inputting the acquired data of the first sensor to a learned model and causing the learned model to output a predicted value. The learned model is generated by performing machine learning of a learning model using learning data generated when the data of the first sensor is regarded as input data and data of a second sensor measuring the workpiece in a relatively longer cycle than the first sensor is regarded as label data indicating a property of the input data.

According to this aspect, the acquired data of the first sensor is input to the learned model and the learned model is caused to output a predicted value. Here, since the learned model is generated using the learning data generated when the data of the first sensor is regarded as the input data and the data of the second sensor is regarded as the label data indicating the property of the input data, the predicted value can be output using the data of the first sensor of which the measurement cycle is relatively shorter than that of the second sensor as an input. Thus, it is possible to predict an abnormality or a sign of an abnormality of the workpiece early in accordance with the predicted value.

### Effects of Invention

According to the present invention, it is possible to detect an abnormality or a sign of an abnormality in a workpiece early.

### BRIEF DESCRIPTION OF DRAWINGS

FIG. 1 is a block diagram illustrating an exemplary general configuration of an optical measurement device according to an embodiment.

FIG. 2 is a block diagram illustrating an exemplary physical configuration of a master unit and slave units according to an embodiment.

FIG. 3 is a block diagram illustrating an exemplary configuration of functional blocks of the master unit according to an embodiment.

FIG. 4 is a block diagram illustrating an exemplary general configuration of a first example of a line according to an embodiment.

FIG. 5 is a flowchart illustrating a general operation of a setting mode process of the master unit according to an embodiment.

FIG. 6 is a flowchart illustrating an exemplary general operation of a prediction learning process of the master unit according to an embodiment.

FIG. 7 is a conceptual diagram illustrating mapping of input data and label data in a generation unit.

FIG. 8 is a flowchart illustrating an exemplary general operation of a selection learning process for the master unit according to an embodiment.

FIG. 9 is a flowchart illustrating an exemplary general operation of a first sensor selection mode process of the master unit according to an embodiment.

FIG. 10 is a flowchart illustrating a general operation of a prediction mode process of the master unit according to an embodiment.

FIG. 11 is a block diagram illustrating an exemplary general configuration of a second example of the line according to an embodiment.

### DESCRIPTION OF EMBODIMENTS

Hereinafter, embodiments of the present invention will be described. In the following description of the drawings, the same or similar reference numerals are given to the same or similar portions. Here, the drawings are schematic. Accordingly, specific dimensions and the like are compared and determined in the following description. Of course, the drawings include portions in which relations or ratios of dimensions differ. Further, the technical scope of the present invention should not be construed to be limited by the embodiments.

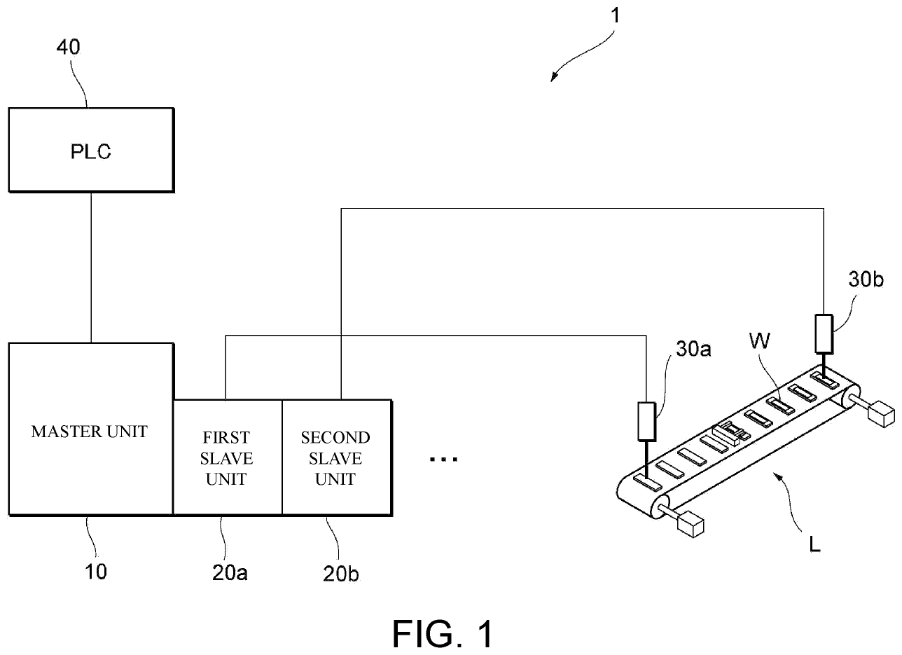

First, a configuration of a sensor system according to an embodiment will be described with reference to FIG. 1. FIG. 1 is a block diagram illustrating an exemplary general configuration of a sensor system 1 according to the embodiment.

As illustrated in FIG. 1, the sensor system 1 includes, for example, a master unit 10, a first slave unit 20a, a second slave unit 20b, a first sensor 30a, a second sensor 30b, and a PLC 40. The master unit 10 according to the embodiment is also equivalent to an example of a “prediction device.”

The first sensor 30a and the second sensor 30b are installed along a line L1. On the line L, workpieces W are transported in a direction from the left to the right (the front to the rear in the drawing) in FIG. 1. The first sensor 30a and the second sensor 30b measure data related to the workpieces W transported on the line L, for example, data indicating passage situations. Measurement cycles of the first sensor 30a and the second sensor 30b are different from each other. The second sensor 30b measures the workpieces W in a relatively longer cycle than the first sensor 30a. That is, the first sensor 30a measures the workpieces W in a relatively shorter cycle than the second sensor 30b.

The line L is not limited to the example illustrated in FIG. 1. The line L may be a line in which the workpieces W move. For example, any type of line L such as a transportation line on which the workpieces W are transported, a manufacturing line on which the workpieces W are manufactured, or a production line in which the workpieces W are produced can be used.

The workpieces W are not limited to a case of a final product and may be, for example, intermediate products, semi-manufactured products, components, materials, or the like.

The first slave unit 20a is connected to the first sensor 30a and the second slave unit 20b is connected to the second sensor 30b. The master unit 10 is connected to the first slave unit 20a, the second slave unit 20b, and the PLC 40. In the present specification, the first slave unit 20a and the second slave unit 20b are collectively referred to as the slave units 20. The first sensor 30a and the second sensor 30b are collectively referred to as the sensors 30.

In the embodiment, an example in which the sensor system 1 includes one first sensor 30a, one second sensor 30b, and two slave units will be described, but the present disclosure is not limited thereto. Any number of first sensors, any number of second sensors, and any number of slave units included in the sensor system 1 can be used and may be appropriately changed. The sensor system 1 may not include the PLC 40.

The master unit 10 is connected to the PLC 40 via a communication network such as a local area network (LAN). The slave units 20 are physically and electrically connected to the master unit 10. In the embodiment, the master unit 10 stores information received from the slave units 20 in a storage unit and transmits the stored information to the PLC 40. Accordingly, data acquired by the slave units 20 is unified and transmitted to the PLC 40 by the master unit 10.

Specifically, a determination signal and detected information are transmitted from the slave units 20 to the master unit 10. The determination signal is, for example, a signal which is determined by the second slave unit 20b based on data measured by the second sensor 30b and indicates a determination result related to workpieces. For example, when the second sensor 30b is a photoelectronic sensor, the determination signal is an ON signal or an OFF signal obtained by causing the second slave unit 20b to compare an amount of received light measured by the second sensor 30b with a threshold. The detected information is, for example, a detected value obtained through a detection operation of the first slave unit 20a. For example, when the first sensor 30a is a photoelectronic sensor, a detection operation is an operation of transmitting light and receiving light and the detected information is an amount of received light.

The slave units 20 are mounted on the side surface of the master unit 10. As communication between the master unit 10 and the slave units 20, parallel communication or serial communication is used. That is, the master unit 10 is physically connected to the slave units 20 along a serial transmission path and a parallel transmission path. For example, the determination signal may be transmitted from the slave units 20 to the master unit 10 on the parallel transmission path and the detected information may be transmitted from the slave units 20 to the master unit 10 on the serial transmission path. The master unit 10 may be connected to the slave units 20 along any one of the serial transmission path and the parallel transmission path.

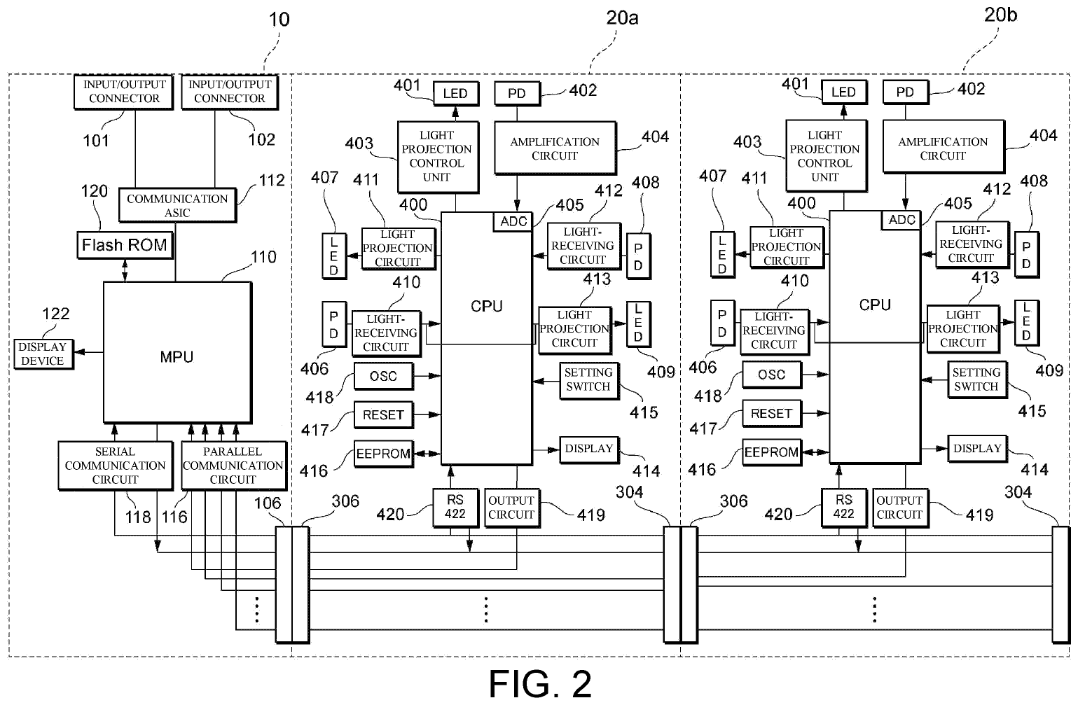

Next, a physical configuration of the master unit and the slave units according to an embodiment will be described with reference to FIG. 2. FIG. 2 is a block diagram illustrating an exemplary physical configuration of the master unit 10 and the slave units 20 according to an embodiment.

As illustrated in FIG. 2, the master unit 10 includes input/output connectors 101 and 102 used for connection to the PLC 40, a connection connector 106 used for connection to the slave units 20, and a power input connector (not illustrated).

The master unit 10 includes a micro processing unit (MPU) 110, a communication application specific integrated circuit (ASIC) 112, a parallel communication circuit 116, a serial communication circuit 118, a flash ROM 120, a display device 122, and a power circuit (not illustrated).

The MPU 110 operates to generally perform all the processes in the master unit 10. The communication ASIC 112 manages communication with the PLC 40. The parallel communication circuit 116 is used for parallel communication between the master unit 10 and the slave units 20. Similarly, the serial communication circuit 118 is used for serial communication between the master unit 10 and the slave units 20. The flash ROM 120 is a nonvolatile memory and stores a learning model. For example, when the learning model is a neural network, the flash ROM 120 may store a weighting parameter or a network structure of the neural network. When the learning model is a regression model or a decision tree, the flash ROM 120 may store a regression parameter or a hyperparameter of the decision tree. The display device 122 is a display such as an organic electro luminescence and displays text information or a state.

In the slave units 20, connectors 304 and 306 for connection to the master unit 10 or between the slave units 20 are provided on both side walls. The plurality of slave units 20 can be connected to the master unit 10 in a line. Signals from the plurality of slave units 20 are transmitted to the adjacent slave units 20 and are transmitted to the master unit 10.

When windows for optical communication of infrared light are provided on both side surfaces of the slave units 20 and the plurality of slave units 20 is connected one by one in a line using the connection connectors 304 and 306, bidirectional optical communication can be performed using the infrared light between the adjacent slave units 20 through the windows for optical communication facing each other.

The slave units 20 have various processing functions implemented by a central processing unit (CPU) 400 and various processing functions implemented by a dedicated circuit.

The CPU 400 controls a light projection control unit 403 and emits infrared light from a light-emitting element (LED) 401. A signal generated when a light-receiving element (PD) 402 receives light is amplified through an amplification circuit 404, subsequently converted into a digital signal through an A/D converter 405, and received by the CPU 400. The CPU 400 transmits received-light data, that is, an amount of received light, as detected information to the master unit 10 without change. The CPU 400 transmits an ON signal or an OFF signal obtained by determining whether the amount of received light is greater than a preset threshold as a determination signal to the master unit 10.

Further, the CPU 400 emits infrared light to the adjacent slave units 20 from left and right communication light-emitting elements (LEDs) 407 and 409 by controlling left and right light projection circuits 411 and 413. The infrared light arriving from the left and right adjacent slave units 20 is received by left and right light-receiving elements (PDs) 406 and 408 and subsequently arrives at the CPU 400 through light-receiving circuits 410 and 412. The CPU 400 performs optical communication with the left and right adjacent slave units 20 by controlling transmitted and received signals based on a predetermined protocol.

The light-receiving element 406, the communication light-emitting element 409, the light-receiving circuit 410, and the light projection circuit 413 are used to transmit and receive a synchronization signal for preventing mutual interference between the slave units 20. Specifically, in each slave unit 20, the light-receiving circuit 410 and the light projection circuit 413 are directly connected. In this configuration, the received synchronization signal is transmitted from the communication light-emitting element 409 to another adjacent slave unit 20 through the light projection circuit 413 quickly without being subjected to a delaying process by the CPU 400.

Further, the CPU 400 controls lighting of the display 414. The CPU 400 processes a signal from the setting switch 415. Various kinds of data necessary for an operation of the CPU 400 are stored in a recording medium such as an electrically erasable programmable read only memory (EEPROM) 416. A signal obtained from a reset unit 417 is transmitted to the CPU 400 to reset measurement control. A reference clock is input from an oscillator (OSC) 418 to the CPU 400.

An output circuit 419 performs a process of transmitting a determination signal obtained by comparing an amount of received light with the threshold. As described above, in the embodiment, the determination signal is transmitted to the master unit 10 through parallel communication.

A transmission path for parallel communication is a transmission path on which the master unit 10 and each slave unit 20 are individually connected. That is, each of the plurality of slave units 20 is connected to the master unit 10 by a separate parallel communication line. Here, a parallel communication line connecting the master unit 10 to a slave unit 20 other than the slave unit 20 adjacent to the master unit 10 can pass another slave unit 20 can pass through the other slave units 20.

A serial communication driver 420 performs a process of receiving a command or the like transmitted from the master unit 10 or a process of transmitting detected information (the amount of received light). In the embodiment, an RS-422 protocol is used for serial communication. An RS-485 protocol may be used for the serial communication.

A transmission path for serial communication is a transmission path on which the master unit 10 and all the slave units 20 are connected. That is, all the slave units 20 are connected such that signals can be transmitted to the master unit 10 in a bus form through the serial communication line.

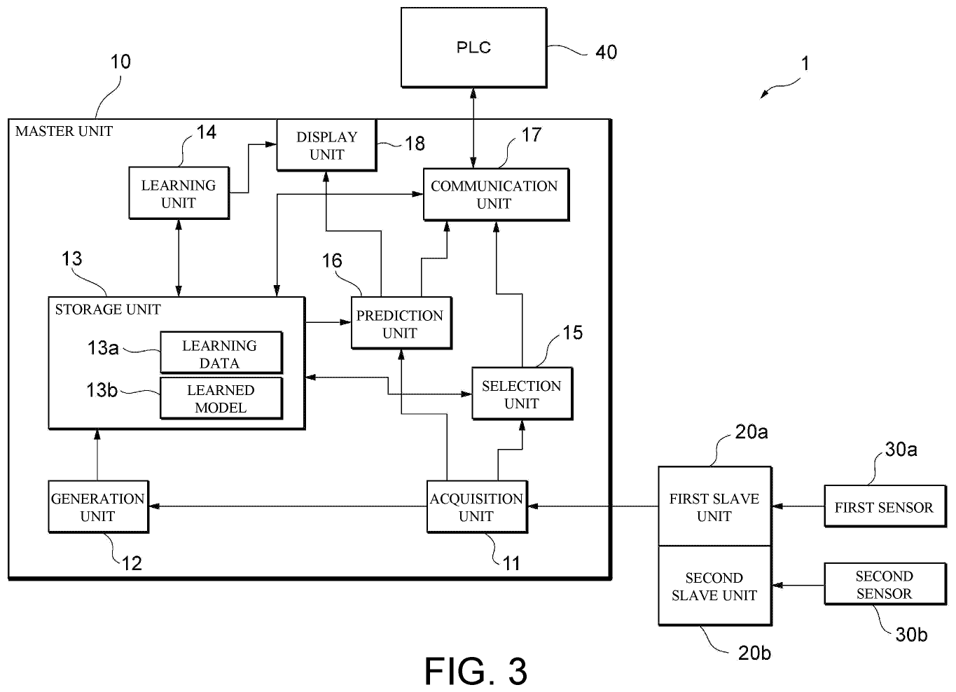

Next, a configuration of functional blocks of the master unit according to an embodiment will be described with reference to FIG. 3. FIG. 3 is a block diagram illustrating an exemplary configuration of functional blocks of the master unit 10 according to an embodiment.

As illustrated in FIG. 3, the master unit 10 includes an acquisition unit 11, a generation unit 12, a storage unit 13, a learning unit 14, a selection unit 15, a prediction unit 16, a communication unit 17, and a display unit 18 as the functional blocks.

The acquisition unit 11 is configured to acquire data measured by the first sensor 30a and data measured by the second sensor 30b via the slave unit 20. Specifically, the acquisition unit 11 acquires detected information measured by the plurality of sensor 30 from the slave units 20 through the serial transmission path.

The generation unit 12 is configured to generate learning data 13a used for machine learning of a learning model. The learning data 13a is data used for supervised learning of the learning model and includes input data and label data. Here, the input data is data input to the learning model during machine learning of the learning model. The input data may be numerical data or may be data in other formats. The label data represents a property of the input data. The property of the input data is a property predicted from the input data and may be, for example, whether there is an abnormality or a sign of an abnormality of the workpiece W transported in the line L, a type of workpiece W, dimensions of the workpiece W, or a positional shift of the workpiece W. The label data is data which the learning model outputs during the machine learning of the learning model and is data considered to be a learning target. The label data may be numerical data or may be data in other formats.

More specifically, the generation unit 12 is configured to set the acquired data of the first sensor 30a as input data of the learning model, set the acquired data of the second sensor 30b as label data used for the supervised learning of the learning model, and generate the learning data 13a including the input data and the label data. In this way, the learning data 13a in which the acquired data of the first sensor 30a is regarded as the input data and the acquired data of the second sensor 30b is regarded as the label data is generated, and thus the learned model generated using the learning data 13a can output a value (a predicted value) using the data of the first sensor 30a of which a measurement cycle is relatively shorter as an input. Accordingly, by using the learned model, it is possible to detect an abnormality or a sign of an abnormality of the workpiece W earlier than in the related art.

The storage unit 13 stores the learning data 13a and a learned model 13b generated by the generation unit 12.

The learning unit 14 is configured to perform the machine learning of the learning model using the learning data 13a and generate the learned model 13b. For example, when the learning model is a neural network, the learning unit 14 may input the input data of the learning data 13a to the neural network and update a weight of the neural network based on a difference between the output and the label data in accordance with an error backward propagation method.

The learning model is not limited to the neural network and may be a regression model or a decision tree. The learning unit 14 may perform the machine learning of the learning model in accordance with any algorithm. In this way, by performing the machine learning of the learning model using the learning data 13a and generating the learned model 13b, it is possible to easily generate the learned model 13b that detects an abnormality or a sign of an abnormality of the workpiece W early.

The selection unit 15 selects one or a plurality of first sensors 30a from a plurality of first sensors 30a. Here, when the plurality of first sensors 30a is installed in the line L, there is a situation in which data which is regarded as input data is limited to improve prediction precision of the learned model. Therefore, the selection unit 15 calculates a value serving as an index when the data of the first sensor 30a is selected, selects one or a plurality of first sensors 30a based on the value, or notifies a user of the value and selects one or a plurality of first sensors 30a.

More specifically, for one of the plurality of first sensors 30a, the selection unit 15 is configured to calculate correlation coefficients of the acquired data of the first sensor 30a and the acquired data of the second sensor 30b. In general, there is a correlation relation between data measured by two sensors 30. Accordingly, when an absolute value is equal to or greater than a predetermined value in the correlation coefficient of the data of the first sensor 30a and the second sensor 30b, the data of the first sensor 30a may be set as the input data. The data of the first sensor 30a in which an absolute value is the maximum in the correlation coefficients of the data of the first sensor 30a and the second sensor 30b may be set as the input data. In this way, by calculating the correlation coefficients of the acquired data of the first sensor 30a and the acquired data of the second sensor 30b, it is possible to select the first sensor 30a that measures data with a linear relation with the data of the second sensor 30b or close to the linear relation among the plurality of first sensors 30a.

The selection unit 15 is configured to calculate a learning progress value based on the acquired data of the second sensor 30b and the predicted value output by inputting the input data to the learned model 13b generated by performing the machine learning of the learning model using the learning data 13a. Here, the learning data 13a used for the selection unit 15 to calculate the learning progress value is generated by the generation unit 12 by using the data acquired from at least one of the plurality of first sensors 30a as the input data. The selection unit 15 generates the learned model 13b using the learning data 13a and calculates a learning progress value indicating a ratio of learning progress of the learned model 13b based on the predicted value output by inputting the above-described input data to the generated learned model 13b. The details of the learning progress value will be described below.

The prediction unit 16 is configured to input the acquired data of the first sensor 30a to the learned model 13b and cause the learned model 13b to output a predicted value. The prediction unit 16 is not limited to a case in which an output of the learned model 13b is used as the predicted value without being changed. For example, the prediction unit 16 may perform any postprocessing on the output of the learned model 13b to output the predicted value. In this way, by inputting the data of the first sensor 30a and causing the learned model 13b to output the predicted value to the learned model 13b, it is possible to predict an abnormality or a sign of an abnormality of the workpiece W early in accordance with the predicted value.

The communication unit 17 is an interface that performs communication with the PLC 40. The communication unit 17 may perform communication with an external device other than the PLC 40.

The display unit 18 displays text information or a state to notify the user. Display targets of the display unit 18 are, for example, numerical data such as a predicted value or a learning progress rate and significance of the numerical data, a state such as a determination result, predicable notification, or a present mode, and a set value of the master unit 10.

In the embodiment, the example in which the master unit 10 includes the functional blocks illustrated in FIG. 3 has been described, but the present disclosure is not limited thereto. For example, when the master unit 10 fulfills a role of a prediction device that predicts an abnormality or a sign of an abnormality of the workpiece W, the master unit 10 includes the acquisition unit 11 that acquires data measured by the first sensor 30a and the prediction unit 16 that inputs the acquired data of the first sensor 30a to the learned model 13b and causes the learned model 13b to output a predicted value. Thus, the acquired data of the first sensor 30a is input to the learned model 13b and the learned model 13b is caused to output the predicted value. Here, the learned model 13b is generated using the learning data 13a generated when the data of the first sensor 30a is regarded as the input data and the data of the second sensor 30b is regarded as the label data indicating the property of the input data. Therefore, it is possible to output the predicted value using the data of the first sensor 30a of which a measurement cycle is relatively shorter than that of the second sensor 30b, as the input data. Accordingly, it is possible to predict an abnormality or a sign of an abnormality of the workpiece W early in accordance with the predicted value.

When the master unit 10 is a prediction device that predicts an abnormality or a sign of an abnormality of the workpiece W, the learned model 13b used by the prediction unit 16 and the learning data 13a used to generate the learned model 13b may be generated by another device such as an external device. It is not necessary for the sensor unit 10 to include the storage unit 13 storing the learned model 13b. For example, the learned model 13b may be stored in another device such as an external device, and the prediction unit 16 may transmit the acquired data of the first sensor 30a to the other device via the communication unit 17 and receive the predicted value from the other device via the communication unit 17.

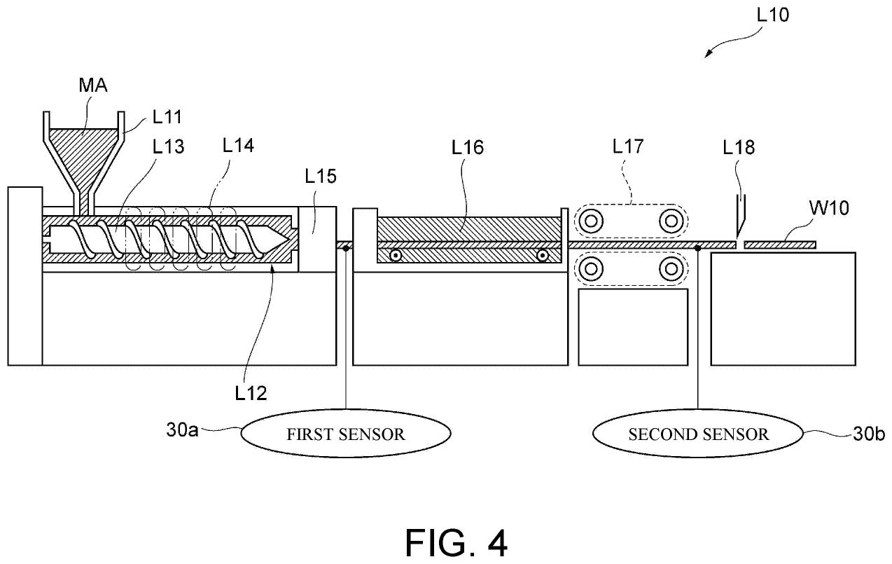

Next, a first example of the line in which the first and second sensors are installed according to the embodiment will be described with reference to FIG. 4. FIG. 4 is a block diagram illustrating an exemplary general configuration of a first example of the line L according to an embodiment.

As illustrated in FIG. 4, a line L10 in which the first sensor 30a and the second sensor 30b are installed is used to extrude, for example, a material MA at a speed controlled while heating the material MA and form a workpiece W10. The line L10 includes a hopper L11, a heating cylinder L12, a die L15, a cooling device L16, a pulling device L17, and a cutting device L18.

The hopper L11 is a container that accommodates the material MA of the workpiece W10. The material MA is supplied from a discharge port to the inside of the heating cylinder L12. The material MA is, for example, a resin. The heating cylinder L12 includes a screw L13 and a heater L14. The heating cylinder L12 extrudes the material MA supplied to the inside while the material MA is churned by the screw L13 so that heat of the heater L14 is uniformly applied to the material MA. An extrusion speed of the screw L13 and a temperature of the heater L14 may be uniform or may be varied.

The material MA extruded from the heating cylinder L12 is discharged as the workpiece W10 with a predetermined thickness (a diameter) via the die L15. The workpiece W10 is subsequently supplied to the cooling device L16. The cooling device L16 deprives the workpiece W10 of the heat of the heater L14 to cool the workpiece W10 to a predetermined temperature. The cooling device L16 may be of, for example, an air cooling type or a water cooling type regardless of a technique for cooling the workpiece W10.

The workpiece W10 extruded from the cooling device L16 is supplied to the pulling device L17 and is subsequently supplied to the cutting device L18. The cutting device L18 cuts the workpiece W10 at a controlled timing. Thus, the workpiece W10 with the predetermined thickness (the diameter) and a predetermined length is formed.

In the line L10, for example, the first sensor 30a is installed at a position between the die L15 and the cooling device L16 and the second sensor 30b is installed at a position between the pulling device L17 and the cutting device L18.

In the line L10, the first sensor 30a is, for example, a transmissive photoelectronic sensor, and a light projector and a light receiver are installed at positions facing each other with the workpiece W10 therebetween. Light emitted from the light projector is blocked in accordance with the thickness (the diameter) of the workpiece W10 and the amount of light which has not been blocked is measured by the light receiver. The first sensor 30a outputs the measured amount of received light as data regarding the amount of received light of the workpiece W10. The first sensor 30a can measure the amount of received light in a relatively shorter cycle and outputs the data regarding the amount of received light of the workpiece W10, for example, every 10 [μs].

In the line L10, the second sensor 30b is, for example, a laser type of measurement sensor, and a light projector and a light receiver are installed at positions facing each other with the workpiece W10 therebetween. Laser light emitted from the light projector is blocked in accordance with the thickness (the diameter) of the workpiece W10 and the thickness (the diameter) of the workpiece W10 is measured based on laser light incident on the light receiver without being blocked. The second sensor 30b outputs thickness (diameter) data of the workpiece W10. A resolution of the thickness (diameter) data output by the second sensor 30b is, for example, 10 [μm]. The second sensor 30b can measure the thickness (diameter) of the workpiece W10 in a relatively longer cycle and outputs the thickness (diameter) data of the workpiece W10, for example, every 500 [μs].

The first sensor 30a is installed upstream (on the left side in FIG. 4) from the second sensor 30b in the line L10 in which the workpiece W10 is moving. Thus, compared to a case in which the first sensor 30a is installed downstream (on the right side in FIG. 4) from the second sensor 30b, the generated learned model 13b can predict an abnormality or a sign of an abnormality of the workpiece W10 earlier since data measured with regard to the workpiece W10 in a relatively earlier stage in the line L10 is input data.

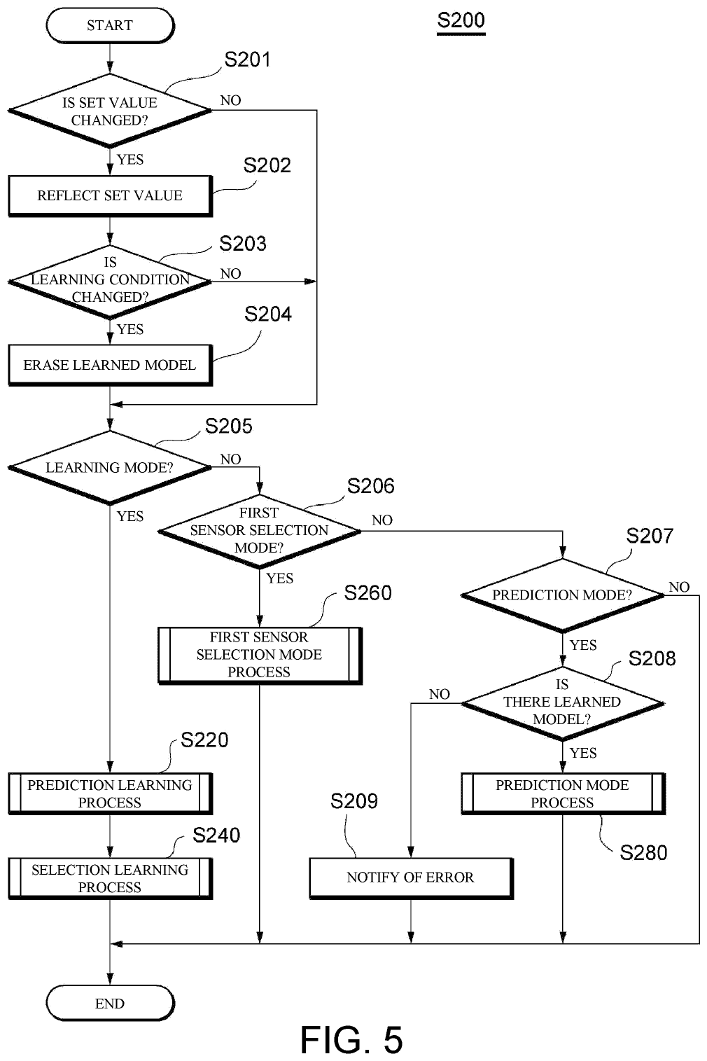

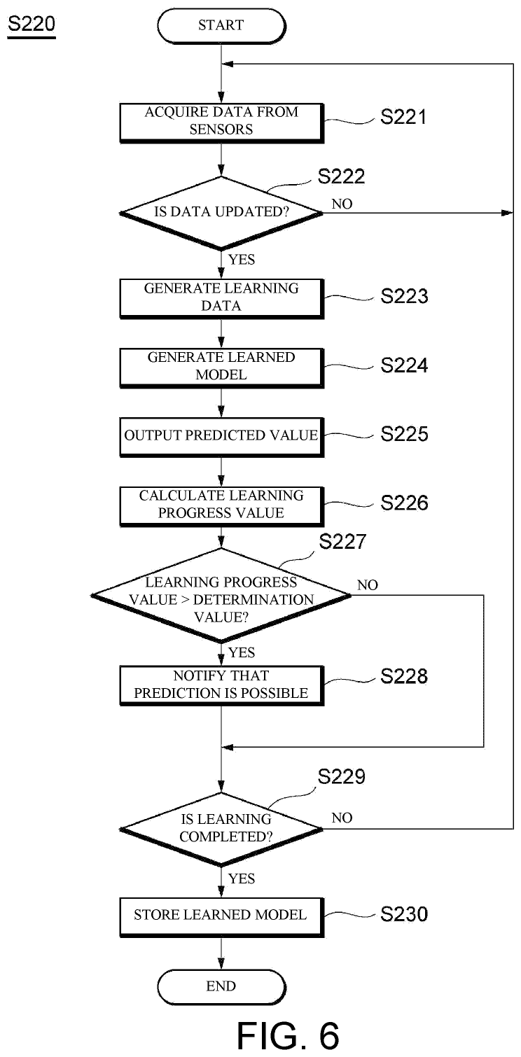

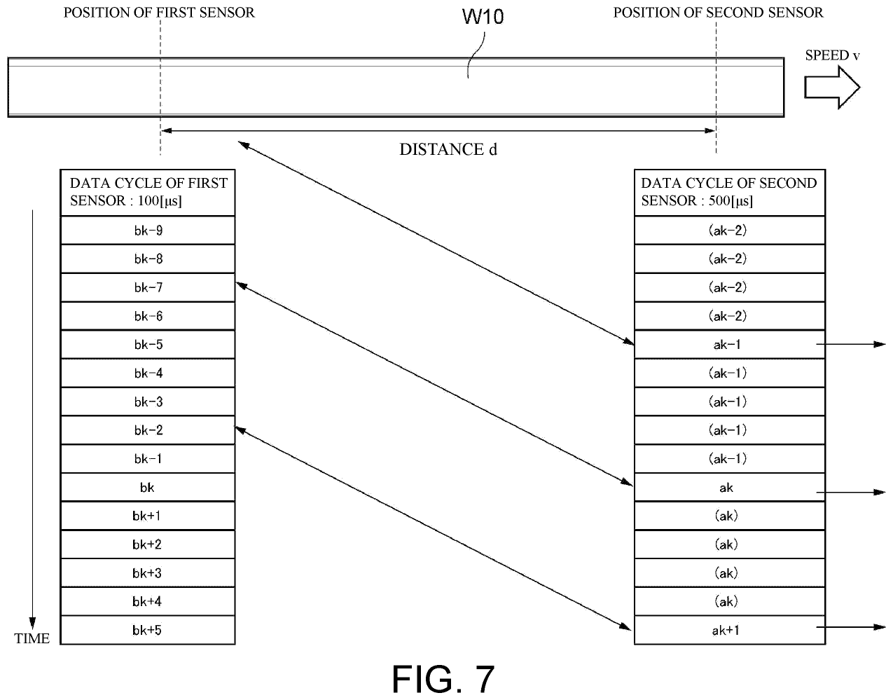

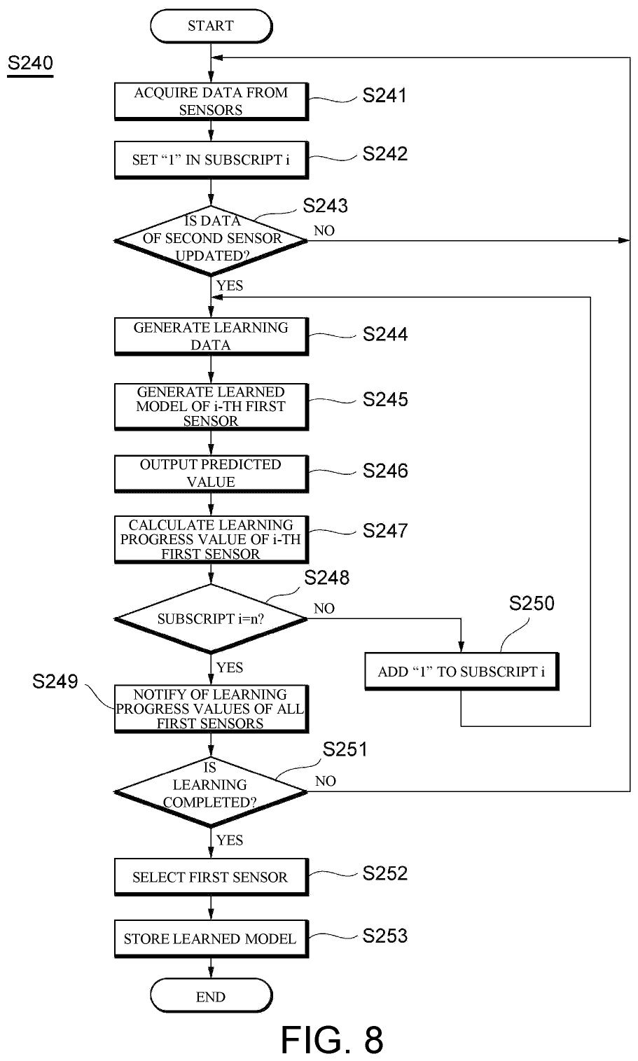

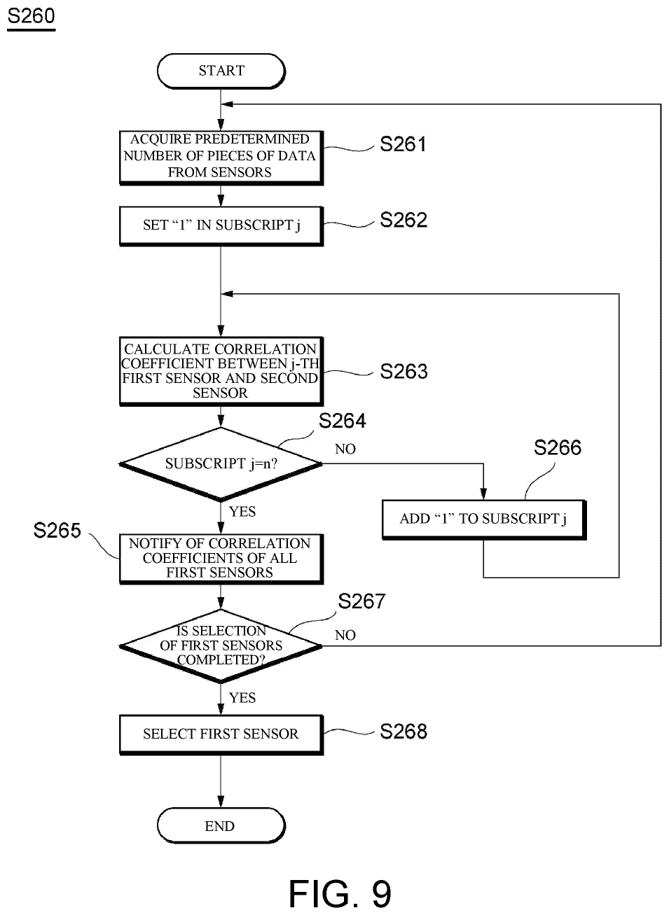

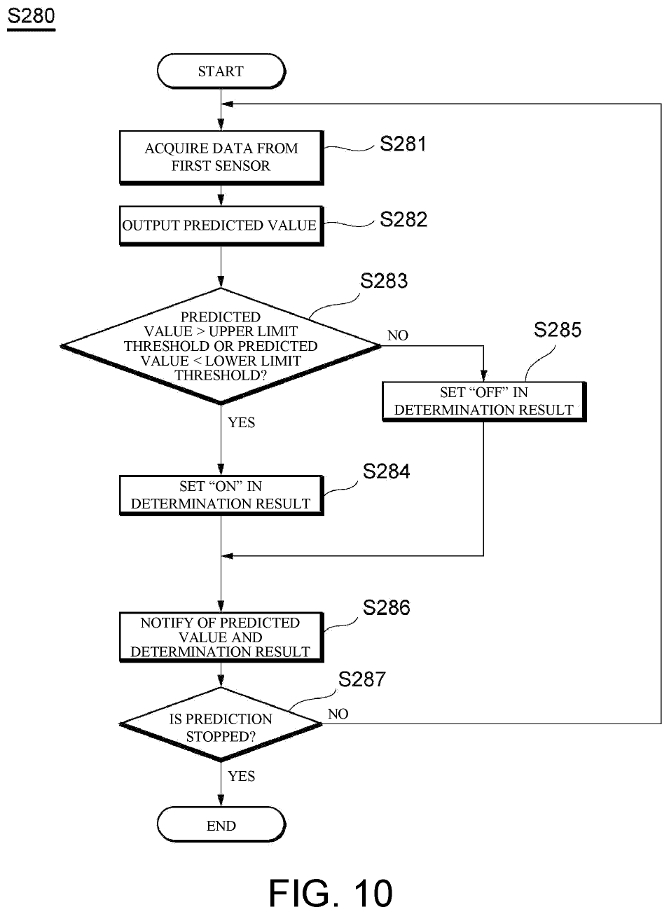

Next, an example of an operation of the master unit according to an embodiment will be described with reference to FIGS. 5 to 10. FIG. 5 is a flowchart illustrating a general operation of a setting mode process S200 of the master unit 10 according to an embodiment. FIG. 6 is a flowchart illustrating an exemplary general operation of a prediction learning process S220 of the master unit 10 according to an embodiment. FIG. 7 is a conceptual diagram illustrating matching of input data and label data in the generation unit 12. FIG. 8 is a flowchart illustrating an exemplary general operation of a selection learning process S240 for the master unit 10 according to an embodiment. FIG. 9 is a flowchart illustrating an exemplary general operation of a first sensor selection mode process S260 of the master unit 10 according to an embodiment. FIG. 10 is a flowchart illustrating a general operation of a prediction mode process S280 of the master unit 10 according to an embodiment.

The master unit 10 has a plurality of modes, for example, a setting mode in which setting necessary to perform each mode is performed, a learning mode in which the learned model is generated, and a prediction mode in which prediction is performed using the learned model. When the plurality of first sensors 30a is installed in the line L, the master unit 10 may further have a first sensor selection mode. The user can perform a manipulation of selecting the modes of the master unit 10.

The master unit 10 performs the setting mode process S200 illustrated in FIG. 5, for example, when a mode is changed through a manipulation of the user. An example in which the first sensor 30a and the second sensor 30b are installed in the line L10 illustrated in FIG. 4 except for cases stated in particular will be described below.

<Setting Mode Process>

As illustrated in FIG. 5, the master unit 10 first determines whether various kinds of set values input through a manipulation of a user are changed from present values (S201). The various kinds of set values are, for example, a set value for the first sensor 30a, a set value for the second sensor 30b, a time difference Δt between the sensors used by the master unit 10, as will be described below, a determination value, an upper limit threshold, a lower limit threshold, setting for determining additional learning at the time of generation of the learned model, and the like.

When any of the various kinds of set values is changed from the present value as a result of the determination of step S201, the master unit 10 reflects content after the set value is changed (S202). After step S202, the master unit 10 determines whether a learning condition is changed (S203). For example, when at least a plurality of first sensors 30a or at least a plurality of second sensors 30b is installed and the first sensor 30a is changed to another first sensor 30a through setting and/or the second sensor 30b is changed to another second sensor 30b, it is determined that the learning condition is changed.

When the learning condition is changed as a result of the determination of step S203, the master unit 10 erases the learned model 13b stored in the storage unit 13 (S204). The master unit 10 erases the learned model 13b or may temporarily evacuate the learned model 13b stored in the storage unit 13 by transmitting the learned model 13b to an external device, for example, the PLC 40, or writing the learned model 13b on another storage device instead of erasing the learned model 13b.

When the set value is not changed as a result of the determination of step S201, the learning condition is not changed as a result of the determination of step S203, or after step S204, the master unit 10 determines whether the present mode is a learning mode (S205).

When the present mode is the learning mode as a result of the determination of step S205, the master unit 10 performs the prediction learning process S220 and the selection learning process S240 to be described below. The master unit 10 ends the setting mode process S200 after the prediction learning process S220 and the selection learning process S240.

The time at which the selection learning process S240 is performed is not limited to the case in which the selection learning process S240 is performed after the prediction learning process S220. The selection learning process S240 may be performed before the prediction learning process S220 or may be performed in parallel with the prediction learning process S220. When the number of first sensors 30a is only one or the number of first sensors 30a is plural and data of the plurality of first sensors 30a is all used, the master unit 10 may not perform the selection learning process S240.

Conversely, when the present mode is not the learning mode as a result of the determination of step S205, the master unit 10 determines whether the present mode is a first sensor selection mode (S206).

When the present mode is the first sensor selection mode as a result of the determination of step S206, the master unit 10 performs the first sensor selection mode process S260 to be described below. The master unit 10 ends the setting mode process S200 after the first sensor selection mode process S260.

When the number of first sensors 30a is plural and it is necessary to select at least one of the plurality of first sensors 30a, the master unit 10 may perform at least one of the selection learning process S240 and the first sensor selection mode process S260. Any first sensor 30a may be selected from the plurality of first sensors 30a through a manipulation of the user. In this case, when the user selects the first sensor 30a different from the previous first sensor 30a, the master unit 10 determines that the learning condition is changed in the determination of step S203.

Conversely, when the present mode is not the first sensor selection mode as a result of the determination of step S206, the master unit 10 determines whether the present mode is a prediction mode (S207).

When the present mode is the prediction mode as a result of the determination of step S207, the master unit 10 determines whether there is the learned model 13b with reference to the storage unit 13 (S208).

When there is the learned model 13b as a result of the determination of step S208, the master unit 10 performs the prediction mode process S280 to be described below. The master unit 10 ends the setting mode process S200 after the prediction mode process S280.

Conversely, when there is no learned model 13b as a result of the determination of step S208, the master unit 10 transmits an error signal to the PLC 40 or an external device via the communication unit 17 and displays an error on the display unit 18 to notify the user of the error (S209). The master unit 10 ends the setting mode process S200 after step S209.

<Prediction Learning Process>

When the prediction learning process S220 is started, as illustrated in FIG. 6, the acquisition unit 11 acquires data from the sensors 30 via the slave unit 20 (S221).

Subsequently, the generation unit 12 determines whether any of the acquired data is updated (S222).

When any of the acquired data is updated as a result of the determination of step S222, the generation unit 12 generates the learning data 13a (S223). The generated learning data 13a is stored in the storage unit 13. Subsequently, the learning unit 14 performs the machine learning of the learning model using the learning data 13a to generate the learned model 13b (S224). The generated learned model 13b outputs a predicted value when input data is input. When there has already been the learned model, the learning unit 14 performs additional learning using the learning data 13a to generate the updated learned model 13b.

The generated learned model 13b is not limited to a case in which the predicted value is output once using the input data which has been input once. For example, the learned model 13b may output a predicted value using input data which has been input a plurality of times at different timings. Even in this case, when a measurement cycle is sufficiently short, an advantageous effect of making prediction early is maintained.

Conversely, when the acquired data is not all updated as a result of the determination of step S222, the master unit 10 repeats steps S221 and S222 until any of the acquired data is updated.

After step S224, the prediction unit 16 inputs the acquired data of the first sensor 30a as the input data to the learned model 13b and causes the learned model 13b to output the predicted value (S225). Subsequently, the learning unit 14 calculates a learning progress value of the learned model 13b based on the output predicted value (S226). The learning progress value is an index indicating a progress state in the machine learning of the learning model and indicates, for example, a ratio (%) of the learning progress of the learned model 13b. The learning progress value is expressed as in Expression (1) below using a measured value A which is data of the second sensor 30b and a predicted value A′ of the learned model 13b.

Learning progress value=100−|A″A′|/A×100 (1)

A method of expressing the learning progress value is not limited to Expression (1). For example, the learning progress value may be an absolute value of a difference between the measured value and the predicted value, as in |A-A′|. In this case, the learning progress value indicates that progress is better as the value is smaller, that is, prediction is correctly performed.

Subsequently, the learning unit 14 compares the calculated learning progress value with a predetermined determination value and determines whether the learning progress value is greater than the predetermined value (S227).

When the learning progress value is greater than the determination value as a result of the determination of step S227, the learning unit 14 transmits a signal to the PLC 40 or an external device via the communication unit 17 and displays the transmission of the signal on the display unit 18 to notify the user that prediction is possible in the prediction mode (S228). At this time, the learning unit 14 may notify of the learning progress value along with the fact that the prediction is possible. Thus, the user can know that the learned model 13b capable of predicting a state of the workpiece W10 is generated.

Conversely, when the learning progress value is equal to or less than the determination value as a result of the determination of step S227 or after step S228, the learning unit 14 determines whether the learning is completed based on a manipulation of the user (S229).

When the learning is completed as a result of the determination of step S229, the learning unit 14 stores and preserves the learned model generated in step S224 in the storage unit 13 (S230) and ends the prediction learning process S220.

Conversely, when the learning is not completed as a result of the determination of step S229, the master unit 10 repeats steps S221 to S229 until the learning is completed.

When the learning data 13a is generated in step S223, various aspects can be considered as combinations of the input data and the label data. Here, as illustrated in FIG. 7, a case in which a measurement cycle of the first sensor 30a is 100 [μs], a measurement cycle of the second sensor 30b is 500 [μs], and from the first sensor 30a and the second sensor 30b are distant by a distance d, the workpiece W10 is moving at a speed v will be considered. The measurement cycle of the second sensor 30b is 5 times the measurement cycle of the first sensor 30a. The second sensor 30b continuously outputs data ak until the data ak is measured and subsequent data ak+1 is then measured (indicated by parentheses in FIG. 7).

The distance d is not limited to the case of a distance between the installation position of the first sensor 30a and the installation position of the second sensor 30b. For example, when a case in which the workpiece W10 moves in an X axis direction, an optical axis of the first sensor 30a is parallel to the Y axis, and an optical axis of the second sensor 30b is parallel to the Z axis is assumed, a distance between measurement points on the workpiece W10 is meaningful rather than the distance between the installation positions of the sensors 30. In this case, the distance d is a distance between a measurement point of the first sensor 30a and a measurement point of the second sensor 30b.

For example, when the time difference Δt (=distance d/speed v) is 700 [μs], the generation unit 12 regards the data ak of the second sensor 30b as the label data and matches data bk-7 of the first sensor 30a as the input data. Similarly, the generation unit 12 regards the data ak+1 of the second sensor 30b as the label data and matches data bk-2 of the first sensor 30a as the input data. In this way, by matching the input data to the label data based on the time difference Δt, the measurement cycle of the first sensor 30a, and the measurement cycle of the second sensor 30b and generating the learning data 13a, the learning data 13a in which the data measured with regard to the same or similar workpieces W10 is matched is generated. Therefore, it is possible to improve prediction accuracy of the learned model 13b.

As the speed v, a preset value may be used. The speed v may be acquired by a device transfer mechanism, for example, a rotary encoder mounted on a motor or the like. In particular, when the speed v is not constant, the generation unit 12 can match the input data to the label data with high accuracy.

In the example illustrated in FIG. 7, the example in which when the data of the second sensor 30b is updated, the generation unit 12 regards the data as the label data, matches the corresponding data of the first sensor 30a as the input data based on the time difference Δt, the measurement cycle of the second sensor 30b, and the measurement cycle of the second sensor 30b, and generates the learning data 13a has been described, but the present disclosure is not limited thereto. For example, when the data of the first sensor 30a is updated, the generation unit 12 may regard the data as the input data, matches the corresponding data of the second sensor 30b as the label data based on the time difference Δt, the measurement cycle of the first sensor 30a, and the measurement cycle of the second sensor 30b, and generates the learning data 13a.

The measurement cycle of at least one of the first sensor 30a and the second sensor 30b may not be constant. In this case, when measurement times of the sensors 30, that is, time stamps, are recorded in association with measurement results and the generation unit 12 combines the measurement times of the first sensor 30a and the second sensor 30b in consideration of the time difference Δt, the input data can be matched to the label data.

An example in which n (where n is an integer equal to or greater than 2) first sensors 30a are installed at the same positions or substantially the same positions as those of the line L10 when the plurality of first sensors 30a are mentioned will be described below.

<Selection Learning Process>

When the selection learning process S240 is started, as illustrated in FIG. 8, the acquisition unit 11 acquires the data from the sensors 30 via the slave unit 20 (S241). Subsequently, the selection unit 15 sets “1” in a subscript i (S242). The subscript i represents a number of each of n first sensors 30a and takes an integer value from “1” to “n.”

Subsequently, the generation unit 12 determines whether the data of the second sensor 30b is updated among the acquired data (S243).

When the data of the second sensor 30b is updated as a result of the determination of step S243, the generation unit 12 generates the learning data (S244). The generated learning data is stored in the storage unit 13. Subsequently, the selection unit 15 generates a learned model of an i-th first sensor 30a through the machine learning using the learning data 13a (S245). In this way, the learned model is generated for each first sensor 30a. The generated learned model outputs a predicted value when the data of the i-th first sensor 30a as is input as the input data. When there has already been the learned model of the i-th first sensor 30a, the selection unit 15 performs additional learning using the learning data 13a and generates an updated learned model.

Conversely, when the data of the second sensor 30b is not updated as a result of the determination of step S243, the master unit 10 repeats steps S241 to S243 until the data of the second sensor 30b is updated.

After step S245, the selection unit 15 regards the data acquired from the i-th first sensor 30a as the input data, inputs the data to the learned model of the i-th first sensor 30a, and causes the learned model to output the predicted value (S246). Subsequently, the selection unit 15 calculates the learning progress value of the learned model of the i-th first sensor 30a based on the output predicted value (S247). A learning progress value can be calculated using Expression (1) similarly to the above-described learning progress value. In this way, by calculating the learning progress value based on the acquired data of the second sensor 30b and the predicted value output by inputting the data acquired from the i-th first sensor 30a to the learned model of the i-th first sensor 30a, at least one of the plurality of first sensors 30a is selected based on the learning progress value. Thus, it is possible to select the first sensor in which the predicted value of the learned model generated from the data of the first sensor 30a is close to the value of the data of the second sensor 30b.

Subsequently, the selection unit 15 determines whether the value of the subscript i is equal to the number n of first sensors 30a (S248).

When the value of the subscript i is equal to the number n of first sensors 30a as a result of the determination of step S248, the selection unit 15 transmits a signal to the PLC 40 or an external device via the communication unit 17 and notifies the user of the learning progress values of the learned models in all the first sensors 30a (S249). Thus, the user can know the learning progress value of the learned model of each first sensor 30a.

Conversely, when the value of the subscript i is not equal to the number n of first sensors 30a as a result of the determination of step S249, the selection unit 15 adds “1” to the subscript i (S250). Until the value of the subscript i is equal to the number n of first sensors 30a, the master unit 10 repeats steps S244 to S248 and S250.

After step S249, the selection unit 15 determines whether the learning is completed based on a manipulation of the user (S251).

When the learning is completed as a result of the determination of step S251, the selection unit 15 selects at least one of the plurality of first sensors 30a based on a manipulation of the user (S252). In this case, the user may be notified of and select the first sensor 30a of which the learning progress value of the learned model is the maximum among all the first sensors 30a or the user may be notified of and select the first sensor 30a of which the learning progress value of the learned model is equal to or greater than a predetermined value, for example, 80 [%].

Subsequently, the selection unit 15 stores and preserves the learned model of the selected first sensor 30a in the storage unit 13 (S253) and ends the selection learning process S240. When the learned models of the unselected first sensors 30a may be stored in the storage unit 13 or may be erased, or may be evacuated in another storage device.

Conversely, when the learning is not completed as a result of the determination of step S251, the master unit 10 repeats steps S241 to S251 until the learning is completed.

In the example illustrated in FIG. 8, the example in which the selection unit 15 generates the learned model of each first sensor 30a and calculates the learning progress value has been described, but the present disclosure is not limited thereto. For example, the selection unit 15 may set m (where m is an integer equal to or greater than 2 and less than n) first sensors 30a as a group among n first sensors 30a, generate a learned model for each group, and calculate a learning progress value of the learned model of the group. In this case, the input data is data of all the first sensors 30a included in the group. The selected first sensors 30a are units of groups rather than each first sensor 30a.

<First Sensor Selection Mode Process>

When the first sensor selection mode process S260 is started, as illustrated in FIG. 9, the acquisition unit 11 acquires the predetermined number of pieces of data from the sensors 30 via the slave unit 20 (S261). The predetermined number of pieces of data is, for example, 255 data sets. Subsequently, the selection unit 15 sets “1” in a subscript j (S262). The subscript j represents a number of each of n first sensors 30a and takes an integer number from “1” to “n.”

Subsequently, the selection unit 15 calculates a correlation coefficient between a j-th first sensor 30a and the second sensor 30b using a data group of the j-th first sensor 30a and a data group of the second sensor 30b (S263).

Subsequently, the selection unit 15 determines whether the value of the subscript j is equal to the number n of first sensors 30a (S264).

When the value of the subscript j is equal to the number n of first sensors 30a as a result of the determination of step S264, the selection unit 15 transmits a signal to the PLC 40 or an external device via the communication unit 17 and notifies the user of the correlation coefficients between the data of the second sensor 30b and the data of all the first sensors 30a (S265).

Conversely, when the value of the subscript j is not equal to the number n of first sensors 30a as a result of the determination of step S264, the selection unit 15 adds “1” to the subscript j (S266). Until the value of the subscript j is equal to the number n of first sensors 30a, the master unit 10 repeats steps S263, S264 and S266.

After step S267, the selection unit 15 determines whether the selection of the first sensors 30a is completed based on a manipulation of the user (S267).

When the selection of the first sensors 30a is completed as a result of the determination of step S267, the selection unit 15 selects at least one of the plurality of first sensors 30a based on a manipulation of the user (S268) and ends the first sensor selection mode process S260. In this case, the user may be notified of and select the first sensor 30a of which the absolute value of the correlation coefficient with the data of the second sensor 30b is the maximum among all the first sensors 30a or the user may be notified of and select the first sensor 30a of which the absolute value of the correlation coefficient with the data of the second sensor 30b is equal to or greater than a predetermined value.

Conversely, when the selection of the first sensors 30a is not completed as a result of the determination of step S267, the master unit 10 repeats steps S261 to S267 until the selection of the first sensors 30a is completed.

<Prediction Mode Process>

When the prediction mode process 5280 is started, as illustrated in FIG. 10, the acquisition unit 11 acquires data from the first sensor 30a via the slave unit 20 (S281).

Subsequently, the prediction unit 16 reads the learned model 13b stored in the storage unit 13, inputs the acquired data of the first sensor 30a as input data to the learned model 13b, and causes the learned model 13b to output a predicted value (S282).

Subsequently, the prediction unit 16 determines whether the output predicted value is greater than an upper limit threshold or less than a lower limit threshold (S283). For example, when a prescribed value of the thickness (diameter) of the workpiece W10 is 20 [mm] and an allowable range is ±1 [mm], the upper limit threshold is set to 21 [mm] and the lower limit threshold is set to 19 [mm].

When the predicted value is greater than the upper limit threshold or is less than the lower limit threshold as a result of the determination of step S283, the prediction unit 16 sets “ON” in the determination result (S284). Conversely, when the predicted value is equal to or less than the upper limit threshold or is equal to or greater than the lower limit threshold as a result of the determination of step S283, the prediction unit 16 sets “OFF” in the determination result (S285).

After step S284 or after step S285, the prediction unit 16 transmits a signal to the PLC 40 or an external device via the communication unit 17 and displays the signal on the display unit 18 to notify the user of the predicted value and the determination result (S286). Thus, the user can know whether the thickness (diameter) of the workpiece W10 predicted from the data of the first sensor 30a and the predicted thickness (diameter) of the workpiece W10 are within an allowable range of the prescribed value or outside of the allowable range.

After step S286, the prediction unit 16 determines whether the prediction is stopped based on a manipulation of the user (S287).

When the prediction is stopped as a result of the determination of step S287, the prediction mode process S280 ends.

Conversely, when the prediction is not stopped as a result of the determination of step S287, the master unit 10 repeats steps S281 to S287 until the prediction is stopped.

In the embodiment, the case in which the sensor system 1 and the master unit 10 are applied to the example illustrated in FIG. 4 has been described, but the present disclosure is not limited thereto. The sensor system 1 and the master unit 10 may be applied to the first sensor and the second sensor differently installed in a line of another form.

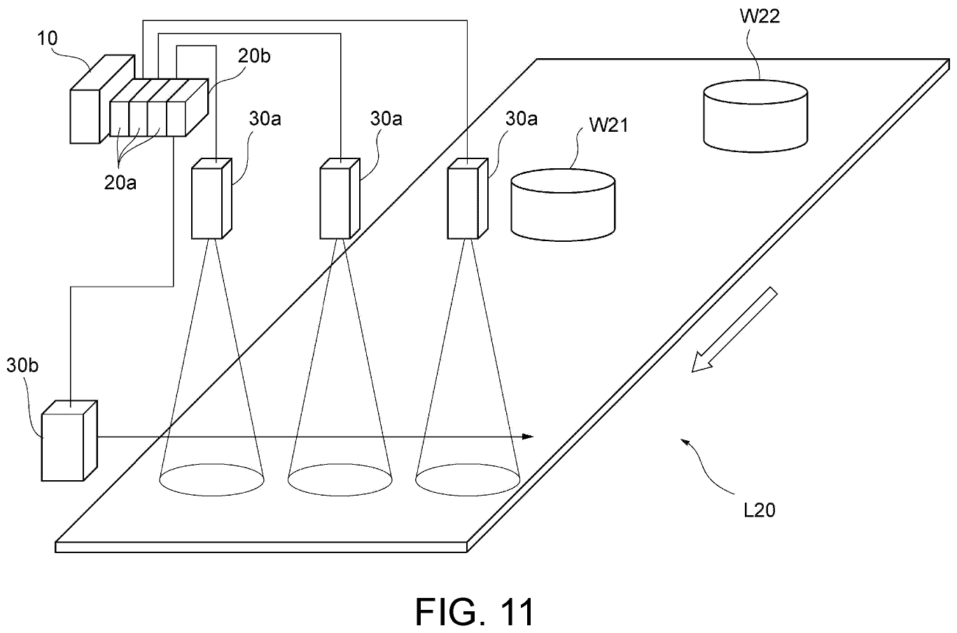

Next, a second example of the line in which the first and second sensors are installed according to an embodiment will be described with reference to FIG. 11. FIG. 11 is a block diagram illustrating an exemplary general configuration of a second example of the line L according to an embodiment.

As illustrated in FIG. 11, in the line L20, a plurality of workpieces W21 and W22 is transported in a direction from the top right to the bottom left in FIG. 11 (the front in the drawing).

Three first sensors 30a and one second sensor 30b are installed at the same positions or substantially the same in the transport direction of the line L20. The three first sensors 30a are installed at a predetermined interval in the width direction (the left and right directions in FIG. 1) of the line L20.

Each first sensor 30a is, for example, a transmissive photoelectronic sensor, and a light projector and a light receiver are integrated. Light emitted from the light projector is reflected from the workpieces W21 and W22 or the background and the light receiver measures an amount of reflected light. Each first sensor 30a outputs the measured amount of received light as data regarding the amount of received light of the workpieces W21 and W22. The first sensors 30a measure the amount of received light in a relatively shorter cycle than the second sensor 30b as in the example illustrated in FIG. 4.

The second sensor 30b is, for example, a displacement sensor, and a light projector and a light receiver are integrated. When the light emitted from the light projector is reflected from the workpieces W21 and W22, distances to the workpieces W21 and W22 are measured based on the reflected light incident on the light receiver. The second sensor 30b outputs data of distances to the workpieces W21 and S22. The second sensor 30b measures the distances to the workpieces W21 and W22 in a relatively longer cycle than the first sensor 30a as in the example illustrated in FIG. 4.

As in the example illustrated in FIG. 4, in the example illustrated in FIG. 11, the master unit 10 can generate learning data in which the data of the three first sensors 30a is regarded as the input data and the data of the second sensor 30b is regarded as the label data.

In the example illustrated in FIG. 11, the first sensor 30a outputs the data regarding the amount of received light and the second sensor 30b outputs the distance data, and thus a physical amount between both the sensors is different. That is, the machine learning of the learning model is performed using the generated learning data and the generated learned model performs conversion of the physical amount in the prediction.

The input data of the learning data is not limited to the case in which output data of the first sensor 30a is used without being changed. For example, data (information) obtained by calculating measured values of the plurality of first sensors 30a may be used as the input data of the learning data.

The label data of the learning data is not limited to the case in which output data of the second sensor 30b is used without being changed. For example, when a sensor measuring a distance (displacement) or a 3-dimensional position is used as the second sensor 30b, the widths or heights of the workpieces W21 and W22 can be obtained by performing calculation such as subtraction or addition on the measured values using two or more second sensors 30b. In this case, such a calculation result may be used as the label data of the learning data.

When the machine learning of the learning model is performed and a learning progress is determined to be sufficient, the master unit 10 may detach the second sensor 30b and predict an operation, that is, an abnormality or a sign of an abnormality of the workpiece W. In this case, it is possible to save cost of the installation.

The exemplary embodiments of the present invention have been described above. The sensor system 1 and the master unit 10 according to an embodiment of the present invention generate the learning data 13a in which the acquired data of the first sensor 30a is regarded as the input data and the acquired data of the second sensor 30b is regarded as the label data.

Thus, the learned model 13b generated using the learning data 13a can output a value (a predicted value) using the data of the first sensor 30a of which the measurement cycle is shorter than that of the second sensor 30b as an input. Accordingly, by using the learned model 13b, it is possible to detect an abnormality or a sign of an abnormality of the workpiece W earlier than in the related art.

In the master unit 10 and the prediction method according to an embodiment of the present invention, the acquired data of the first sensor 30a is input to the learned model 13b and the learned model 13b is caused to output the predicted value. Here, the learned model 13b is generated using the learning data 13a generated when the data of the first sensor 30a is regarded as the input data and the data of the second sensor 30b is regarded as the label data indicating the property of the input data. Therefore, it is possible to output the predicted value using the data of the first sensor 30a of which the measurement cycle is relatively shorter than that of the second sensor 30b, as an input. Accordingly, it is possible to predict an abnormality or a sign of an abnormality of the workpiece W early in accordance with the predicted value.

The above-described embodiments have been described to facilitate the understanding of the present invention and are not construed to limit the present invention. Elements in the embodiments and disposition, materials, conditions, shapes, sizes, and the like of the elements are not limited to the exemplified elements and can be appropriately modified. Configurations in the different embodiments can be partially substituted or combined.

(Supplement 1)

A sensor system (1) including:

a first sensor (30a) configured to measure a workpiece;

a second sensor (30b) configured to measure the workpiece in a relatively longer cycle than the first sensor (30a); and

a master unit (10),

wherein the master unit (10) includes

an acquisition unit (11) that acquires data measured by the first sensor (30a) and data measured by the second sensor (30b), and

a generation unit (12) that generates learning data which is used for machine learning of a learning model and in which the acquired data of the first sensor (30a) is regarded as input data and the acquired data of the second sensor (30b) is regarded as label data indicating a property of the input data.

(Supplement 8)

A master unit (10) used for a sensor system (1) including a first sensor (30a) configured to measure a workpiece and a second sensor (30b) configured to measure the workpiece in a relatively longer cycle than the first sensor (30a), the master unit (10) including:

an acquisition unit (11) configured to acquire data measured by the first sensor (30a) and data measured by the second sensor (30b); and

a generation unit (12) that generates learning data which is used for machine learning of a learning model and in which the acquired data of the first sensor (30a) is regarded as input data and the acquired data of the second sensor (30b) is regarded as label data indicating a property of the input data.

(Supplement 14)

A prediction device (10) predicting an abnormality or a sign of an abnormality of a workpiece, the prediction device (10) including:

an acquisition unit (11) configured to acquire data measured by a first sensor (30a) measuring the workpiece; and

a prediction unit (16) configured to input the acquired data of the first sensor (30a) to a learned model and causes the learned model to output a predicted value,

wherein the learned model is generated by performing machine learning of a learning model using learning data generated when the data of the first sensor (30a) is regarded as input data and data of a second sensor (30b) measuring the workpiece in a relatively longer cycle than the first sensor (30a) is regarded as label data indicating a property of the input data.

(Supplement 15)

A prediction method of predicting an abnormality or a sign of an abnormality of a workpiece, the method comprising:

a step (S281) of acquiring data measured by a first sensor (30a) measuring the workpiece; and

a step (S282) of inputting the acquired data of the first sensor (30a) to a learned model and causing the learned model to output a predicted value,

wherein the learned model is generated by performing machine learning of a learning model using learning data generated when the data of the first sensor (30a) is regarded as input data and data of a second sensor (30b) measuring the workpiece in a relatively longer cycle than the first sensor (30a) is regarded as label data indicating a property of the input data.

### REFERENCE SIGNS LIST

1 Sensor system

10 Master unit

11 Acquisition unit

12 Generation unit

13 Storage unit

13a Learning data

13b Learned model

14 Learning unit

15 Selection unit

16 Prediction unit

17 Communication unit

18 Display unit

20 Slave unit

20a First slave unit

20b Second slave unit

30 Sensor

30a First sensor

30b Second sensor

d Distance

L, L10, L20 Line

L11 Hopper

L12 Heating cylinder

L13 Screw

L14 Heater

L15 Die

L16 Cooling device

L17 Pulling device

L18 Cutting device

MA Material

S200 Setting mode process

S220 Prediction and learning process

S240 Selection learning process

S260 First sensor selection mode process

S280 Prediction mode process

v Speed

W, W10, W21, W22 Workpiece

Δt Time difference

1. A sensor system comprising:
a first sensor configured to measure a workpiece;
a second sensor configured to measure the workpiece in a relatively longer cycle than the first sensor; and
a master unit,
wherein the master unit includes
an acquisition unit that acquires data measured by the first sensor and data measured by the second sensor, and
a generation unit that generates learning data which is used for machine learning of a learning model and in which acquired data of the first sensor is regarded as input data and acquired data of the second sensor is regarded as label data indicating a property of the input data.

2. The sensor system according to claim 1, wherein the generation unit generates the learning data by matching the input data to the label data based on a time difference calculated from a movement speed of the workpiece and a distance between the first sensor and the second sensor, a measurement cycle of the first sensor, and a measurement cycle of the second sensor.

3. The sensor system according to claim 1, wherein the first sensor is installed upstream from the second sensor in a line in which the workpiece is moving.

4. The sensor system according to claim 1, wherein the master unit further includes a learning unit that performs machine learning of the learning model using the learning data to generate a learned model.

5. The sensor system according to claim 4, wherein the master unit further includes a prediction unit that inputs the acquired data of the first sensor to the learned model and causes the learned model to output a predicted value.

6. The sensor system according to claim 1,
wherein a plurality of the first sensors is included, and
wherein the master unit further includes a selection unit that calculates, for one of the plurality of first sensors, a correlation coefficient between the acquired data of the first sensor and the acquired data of the second sensor.

7. The sensor system according to claim 1,
wherein a plurality of the first sensors is included,
wherein the generation unit generates learning data in which data acquired from at least one of the plurality of first sensors is regarded as input data, and
wherein the master unit further includes a selection unit that calculates a learning progress value indicating a ratio of learning progress of the learned model based on the acquired data of the second sensor and a predicted value output by inputting the input data to the learned model generated by performing the machine learning of the learning model using the learning data.

8. A master unit used for a sensor system including a first sensor configured to measure a workpiece and a second sensor configured to measure the workpiece in a relatively longer cycle than the first sensor, the master unit comprising:
an acquisition unit configured to acquire data measured by the first sensor and data measured by the second sensor; and
a generation unit that generates learning data which is used for machine learning of a learning model and in which acquired data of the first sensor is regarded as input data and acquired data of the second sensor is regarded as label data indicating a property of the input data.

9. The master unit according to claim 8, wherein the generation unit generates the learning data by matching the input data to the label data based on a time difference calculated from a movement speed of the workpiece and a distance between the first sensor and the second sensor, a measurement cycle of the first sensor, and a measurement cycle of the second sensor.

10. The master unit according to claim 8, further comprising:
a learning unit configured to perform machine learning of the learning model using the learning data to generate a learned model.

11. The master unit according to claim 10, further comprising:
a prediction unit configured to input the acquired data of the first sensor to the learned model and cause the learned model to output a predicted value.

12. The master unit according to claim 8any one of claims 8 to 11,
wherein the sensor system includes a plurality of the first sensors, and
wherein the master unit further comprises a selection unit that calculates, for one of the plurality of first sensors, a correlation coefficient between the acquired data of the first sensor and the acquired data of the second sensor.

13. The master unit according to claim 8,
wherein the sensor system includes a plurality of the first sensors,
wherein the generation unit generates learning data in which data acquired from at least one of the plurality of first sensors is regarded as input data, and
wherein the master unit further comprises a selection unit that calculates a learning progress value indicating a ratio of learning progress of the learned model based on the acquired data of the second sensor and a predicted value output by inputting the input data to the learned model generated by performing the machine learning of the learning model using the learning data.

14. A prediction device predicting an abnormality or a sign of an abnormality of a workpiece, the prediction device comprising:
an acquisition unit configured to acquire data measured by a first sensor measuring the workpiece; and
a prediction unit configured to input acquired data of the first sensor to a learned model and cause the learned model to output a predicted value,
wherein the learned model is generated by performing machine learning of a learning model using learning data generated when the data of the first sensor is regarded as input data and data of a second sensor measuring the workpiece in a relatively longer cycle than the first sensor is regarded as label data indicating a property of the input data.

15. A prediction method of predicting an abnormality or a sign of an abnormality of a workpiece, the prediction method comprising:
acquiring data measured by a first sensor measuring the workpiece; and
inputting acquired data of the first sensor to a learned model and causing the learned model to output a predicted value,
wherein the learned model is generated by performing machine learning of a learning model using learning data generated when the data of the first sensor is regarded as input data and data of a second sensor measuring the workpiece in a relatively longer cycle than the first sensor is regarded as label data indicating a property of the input data.

16. The sensor system according to claim 2, wherein the first sensor is installed upstream from the second sensor in a line in which the workpiece is moving.

17. The sensor system according to claim 2, wherein the master unit further includes a learning unit that performs machine learning of the learning model using the learning data to generate a learned model.

18. The sensor system according to claim 3, wherein the master unit further includes a learning unit that performs machine learning of the learning model using the learning data to generate a learned model.

19. The sensor system according to claim 2,
wherein a plurality of the first sensors is included, and
wherein the master unit further includes a selection unit that calculates, for one of the plurality of first sensors, a correlation coefficient between the acquired data of the first sensor and the acquired data of the second sensor.

20. The sensor system according to claim 3,
wherein a plurality of the first sensors is included, and
wherein the master unit further includes a selection unit that calculates, for one of the plurality of first sensors, a correlation coefficient between the acquired data of the first sensor and the acquired data of the second sensor.
